(19) United States
(12) Patent Application Publication
(10) Pub. No.: US 2002/0189646 A1
(43) Pub. Date: Dec. 19, 2002

(54) Devices, systems, and methods for transporting a liquid

(76) Inventor: Jeff Williams, Allen, TX (US)

Correspondence Address: Robert C. Klinger, Jackson Walker L.L.P., Suite 600, 2435 North Central Expressway, Richardson, TX, 75080, US

(21) Appl. No.: 09/883,634

(22) Filed: Jun. 18, 2001

(51) Int. Cl. B08B 5/04

(52) U.S. Cl. 134/21

(57) ABSTRACT

The invention provides methods of operating a cleaning solution system. One method applies a vacuum pressure to a liquid, and passes the liquid through the cleaning solution system. An alternative method applies suction to the liquid, processes the liquid, and routes the liquid. The invention also provides systems and devices. One device embodiment is a cleaning compound/fresh water station. This embodiment includes an intake, a pump enabled to pump liquids, and an outlet.

### TECHNICAL FIELD

Generally, the invention relates to the field of cleaning devices.

### STATEMENT OF A PROBLEM ADDRESSED BY THIS INVENTION

Persons who clean floors with floor cleaning tools (for simplicity of discussion, hereinafter, floor cleaning tools are referred to as mops), such as janitors, food service workers, or housekeepers, for example, must frequently clean the mops so that a mop actually cleans the floor, rather than merely swirl around dirt and debris. Accordingly, as the floor is cleaned, the water in the mop bucket becomes dirty. Generally, to keep a mop clean, the person must frequently dump dirty used water from a mop bucket, rinse out the mop bucket, and/or flush the mop bucket with soapy water or sanitized water. Often, this is done at a mop station.

A mop station generally comprises a sink, as well as a water hose, and a space for positioning a mop bucket so that it may be filled with water or other liquids. However, a sink at a mop station is typically elevated. This means that a person must lift the mop bucket to the sink to dump out dirty water. In addition, it is often necessary to fill the mop bucket with water. This is typically done in the sink, or at the sink's level. Thus, the mop bucket must be lowered to the floor level from the sink in order to avoid spilling water around the mop station. Unfortunately, because water weighs more than eight pounds per gallon, and because mop buckets often hold between three and six gallons of water, a full mop bucket may weigh in excess of fifty pounds. Predictably, the lifting and lowering of a mop bucket may cause injuries.

Back strain from mop bucket lifting and lowering is a common workplace injury. According to the Department of Labor, overexertion is the leading cause of injuries for janitors and housekeepers. In fact, in the year 2000, 28% of workplace injuries were due to overexertion, and lifting caused half of those injuries. Accordingly, there exist the need for systems, devices, and methods that save worker time, prevent worker injury from lifting too much weight, prevent worker exposure to hazardous chemicals, and effectively provides the desired liquids to a work area, such as a mop station.

### SELECTED OVERVIEW OF SELECTED EMBODIMENTS

The invention provides technical advantages as a cleaning compound/fresh water system, a cleaning compound/fresh water device, and as methods of operating a cleaning compound/fresh water system. One method applies a vacuum pressure to a liquid, and passes the liquid through the cleaning solution system. An alternative method applies suction to the liquid, processes the liquid, and routes the liquid. The invention also provides systems and devices. One device embodiment is a cleaning compound/fresh water station. This embodiment includes an intake, a pump enabled to pump liquids, and an outlet.

The methods may provide operations, such as a start operation. In addition, the invention may provide for a variety of functions, such as a select function, a set-up, a post operation, or a shut down. In selected embodiments, the invention may incorporate filtering a liquid, sanitizing the liquid, or adding a cleaning compound to the liquid. A timer may be provided for applying suction for a pre-determined period of time for either emptying a mop bucket or for filling the mop bucket. Furthermore, many other functions and operations may also be incorporated into the invention.

In another embodiment, the invention, when embodied as a cleaning compound/fresh water station (the station), may provide a timer coupled to the pump for controllably turning on and off the pump so that a direction of liquid flow and a duration of liquid flow may be controlled. It may also include a means for adding a solution to the liquid, the means coupled to the pump, or a filter coupled to the pump. In other preferred embodiments, the station includes a processor for controlling the functionality of the pump, the processor coupled to the pump.

Accordingly, the invention provides inventive embodiments that save worker time, prevent worker injury from lifting too much weight, prevent worker exposure to hazardous chemicals, and effectively provides the desired liquids to a work area, such as a mop station. Thus, employers will save money due to increased worker productivity, lower insurance rates, fewer workers' compensation claims, and fewer OSHA violations.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a flow-diagram of a liquid transfer algorithm;

FIG. 2 illustrates a cleaning station algorithm;

FIG. 3 is one embodiment of a cleaning compound/fresh water device; and

FIG. 4 shows a cleaning compound/fresh water system.

### AN EXEMPLARY EMBODIMENT OF A BEST MODE

The invention provides inventive embodiments that save worker time, prevent worker injury from lifting weight, prevent worker exposure to hazardous chemicals, and effectively provides the desired liquids to a work area, such as a mop station. One preferred method applies suction to a liquid, processes the liquid, and routes the liquid either to a mop bucket or to a disposal. One preferred device is a cleaning compound/fresh water station that includes an intake, a pump enabled to pump liquids, an outlet, and a timer set to open a valve at a predetermined time so that a predetermined amount of liquid will pass to a mop bucket. Accordingly, among the invention's many advantages that are readily apparent to those of ordinary skill in the art, the invention saves its users money due to increased worker productivity, lower insurance rates, and fewer workers' compensation claims.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—-functioning-” or “step for —functioning-” in the claims section.

Exemplary Methods

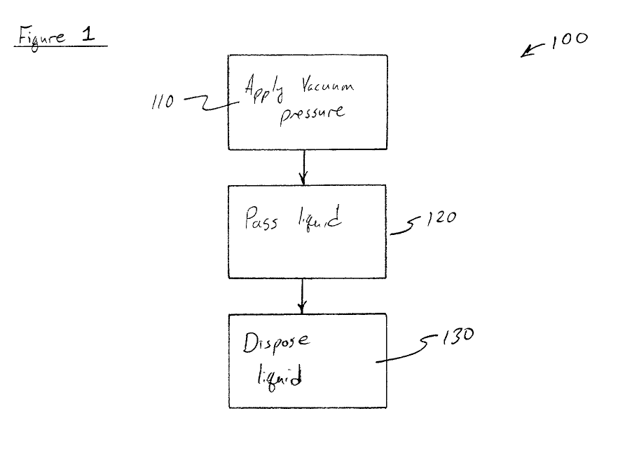

In one embodiment, the invention is a liquid transfer algorithm which generally defines acts which are performed to transfer a liquid, preferably between a mop bucket and a disposal. FIG. 1 is a flow-diagram of a liquid transfer algorithm 100. The liquid transfer algorithm 100 begins with an apply vacuum pressure act 110. In the apply vacuum pressure at 110 a lower than atmospheric pressure is applied to a liquid, such as dirty water in a mop bucket. In one embodiment, the liquid is sucked into a receiving hose attached to an intake. Next, the liquid transfer algorithm 100 proceeds to a pass liquid act 120.

In the pass liquid act 120 the liquid is transferred through a cleaning compound/fresh water device. In addition, pass liquid act 120 may provide for the sanitizing, treating, filtering, or altering of the liquid. Then, following the pass liquid act 120, a dispose liquid act 130 takes place. In the dispose liquid act 130, the liquid is passed to a disposal, such as a sink, a drain in a floor, a basin, or a second bucket. The dispose liquid act 130 may also initiate the filling of the mop bucket with clean water.

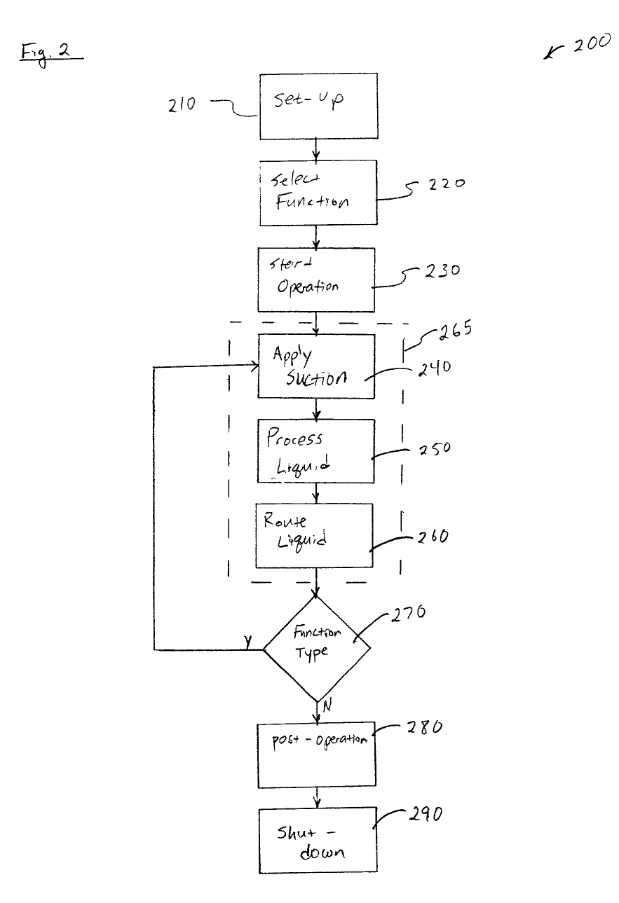

To more fully appreciate the invention, one may consider a cleaning station algorithm. FIG. 2 illustrates a cleaning station algorithm 200. The cleaning station algorithm 200 begins with a set-up act 210 which detects that a bucket that is presumably containing dirty water is present at a mop station, preferably by detecting that a receiving or a disposing hose has been located in dirty water. One way this could be accomplished is with a motion detector. Next, a select function act 220 detects that a user has selected a function, or has programmed a function of his or her own.

For example, one function, called a fill function, may fill a mop bucket with water, such as in three gallon, four gallon, five gallon, or metric increments. Another exemplary function is a drain and fill function in which the invention drains dirty water from a mop bucket and then fills the mop bucket with clean water. Another exemplary function is a drain, rinse, and fill function. In the drain, rinse, and fill function dirty mop water is drained from the mop bucket, then clean water is fed into the mop bucket so that the mop bucket will be rinsed, and then the rinse water is then drained from the mop bucket. Alternatively, the rinse event may include rinsing the mop bucket with sanitized water. Finally, a liquid such as clean water, or soapy water, or sanitized water, for example, is placed in the mop bucket to as to provide sanitized water, clean water, or soapy water for a user.

Another exemplary function is a drain and rinse function. The drain and rinse function drains dirty mop water from a mop bucket and then flushes the mop bucket with clean water in order to rinse the mop bucket. Then, the drain and rinse function removes the rinse water from the mop bucket so that the mop bucket may dry, or be ready for its next use. Yet another exemplary function is a sanitized mop function. The sanitized mop function removes dirty water from the mop bucket, and then flushes the mop bucket with sanitized water. Used mops that are to be sanitized are preferably placed in a cabinet and sprayed with sanitizer, and remain there until the next use. Still another exemplary embodiment of a function is a manual fill function. In the manual fill function dirty mop water is drained from the mop bucket so that a user may fill the mop bucket with their choice of liquids or compounds.

Following the select function act 220, a start operation act 230 takes place. In the start operation the pump begins operation by clearing lines and performing system checks. Furthermore, the start operation act 230 may incorporate a time delay following the set-up act 210 before proceeding. Once the start operation 230 is completed, the cleaning station algorithm 200 proceeds to a liquid passage block 265. The liquid passage block 265 generally defines how a liquid is passed from one side of the cleaning compound/fresh water device to the other side of the cleaning compound/fresh water device.

The liquid passage block 265 begins with an apply suction act 240. In the apply suction act 240 suction is applied to dirty water in a mop bucket. Next, the liquid passage block 265 proceeds to a process liquid act 250. In the process liquid act 250 the liquid is transferred through a cleaning compound/fresh water device. Then, following the process liquid act 250, a route liquid act 260 takes place. In the route liquid act 260, the liquid is passed to a disposal. The route liquid act 260 may also initiate the filling of the mop bucket with clean water.

Following the route liquid act 260, the cleaning station algorithm 200 leaves the liquid passage block 265 and proceeds to a function type query 270. If, in the function type query 270, it is determined that the function selected by a user which is detected in the select function act 220, requires another cleaning compound/fresh water device operation, then the cleaning station algorithm 200 proceeds along the y choice and returns to the apply suction act 240 of the liquid passage block 265. However, if in the function type query 270 it is determined that another cleaning compound/fresh water device operation is not needed, then the cleaning station algorithm 200 proceeds along the n path to a post operation act 280. In the post-operation act 280 pumps and hoses are flushed in the direction of the disposal, and any needed system checks are performed. Then, the cleaning station algorithm 200 proceeds to a shut-down act 290 in which the cleaning compound/fresh water system powers down, and the function selection is reset.

Exemplary Device

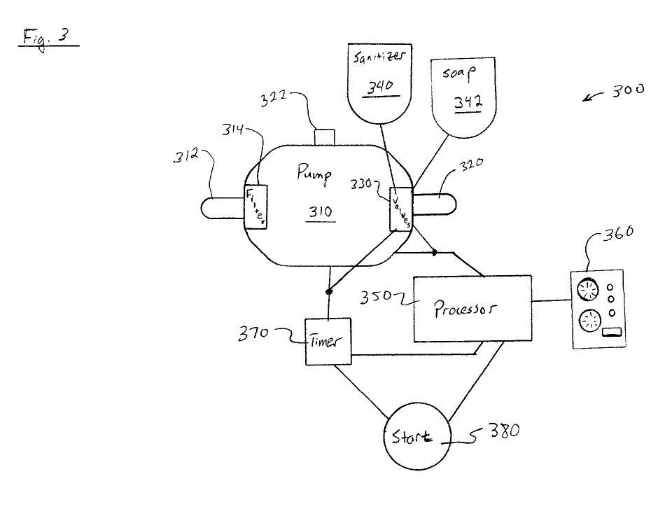

FIG. 3 is one embodiment of a cleaning compound/fresh water device 300 (the device) 300. The device 300 includes a pump, which is preferably an air pump, but which could be embodied as any type pump capable of transporting a liquid from an intake 312 such as a receiving hose attachment, to an outlet 320, such as a disposing hose attachment. In addition, it is preferable for the pump 310 to have a waterline attachment 322 coupled thereto. Preferably, a filter 314 is provided to remove large particulates from dirty water, such as mop bucket water. However, it should be understood that the filter 314 may be used to remove particulate matter from any liquid passing through the pump 310. In addition, the pump 310 maintains a plurality of valves 330 which may be articulated by a timer 370 or a processor 350.

In a preferred embodiment, the invention provides for a separate clean water inlet hose, and a separate dirty water inlet hose (not shown). The clean water inlet hose is then available for dispensing clean water into a bucket without being contaminated with debris or microbes from the dirty water that was emptied from the bucket through the dirty water inlet hose. Similarly, a plurality of hoses may be provided for moving any number of solutions, and these may be based on the compatibility between a hose type and the material the hose passes, as well as on a desire to keep the materials separate.

The valves 330 open and close so as to allow a liquid to flow through the pump 310, and may be articulated to add a sanitizer, water, soap, or other compound to the liquid flowing through the pump 310. Accordingly, a valve is coupled to a sanitizer line 340, and a valve is coupled to a soap line 342. A control system generally comprised of a processor 350, a timer 370, and a start button 380, is used to manipulate the valves 330 in the pump 310.

The processor 350 may be a digital signal processor (DSP), a general purpose processor such as a Pentium Processor, or any other processing means. The timer 370 may be a digital or an analog timer. The start button may be any electrical or mechanical device that sends a signal to the timer 370 or the processor 350 to instruct the cleaning compound/fresh water device 300 to begin operation. In addition, the start button 380 may include input devices capable of allowing a user to select a function, or to define or program a function. Accordingly, the start button 380 may be embodied as a keypad, a keyboard, or as a microphone used to pick up voice commands which are then processed by the processor 350. Furthermore, an indicator 360 is coupled to the processor 350. The indicator 360 may be embodied as a light emitting diode or as a parality of light emitting diodes (LEDs), or as a liquid crystal display (LCD), or as a combination of LED/LCD devices. The indicator 360 may be used to display information provided by the timer 370. Accordingly, the indicator 360 may provide a user visual information regarding the status of cleaning compound/fresh water device operation. The indicator 360 may also provide visual information regarding the operation or function being performed. Furthermore, the indicator 360 may be embodied as a speaker so that the cleaning compound/fresh water device 300 is enabled to provide a user audible information regarding the status of operation.

Exemplary System

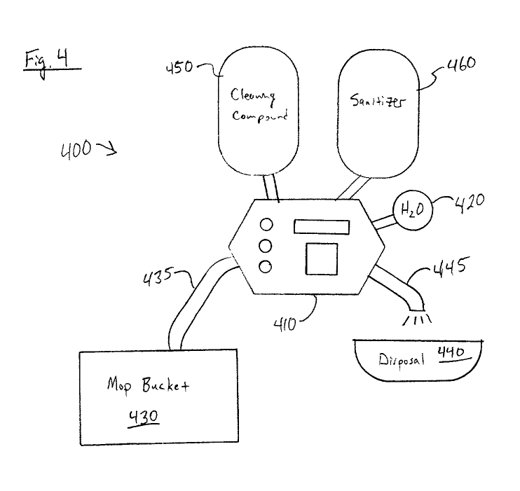

A cleaning compound/fresh water device may be better understood in the context of a cleaning compound/fresh water system embodiment of the invention. Accordingly, FIG. 4 shows a cleaning compound/fresh water system (the system) 400. The system 400 provides a cleaning compound/fresh water device embodied as a pump station 410. The pump station 410 is used to transfer dirty water between a mop water bucket 430 and a disposal 440, and between a fresh water hookup 420 and the mop water bucket 430. Accordingly, a receiving hose 435 is coupled to the pump station 410 in such a way that the receiving hose 435 may also be disposed in a mop water bucket, preferably in such a manner that most of a liquid may be removed from the mop water bucket 430 by applying a vacuum pressure to the liquid in the mop water bucket 430. Likewise, a disposing hose 445 is coupled to the pump station 410 and is also positioned about the disposal 440. Accordingly, the disposal 440 may be a mop station sink, a sewer system line, or other disposal means, but is preferably a drain.

In order to provide a user with what is, in one embodiment, effectively a one-stop mop bucket station, containers are provided so that compounds may be added to water passing through the pump station 410. Accordingly, a first solution container 450 is coupled to the pump station 410 via a valve. Preferably, the first solution container contains a cleaning compound. Similarly, a second solution container 460 maintains sanitizer solution or compound that may pass into the pump station 410 via a valve.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications.

I claim:

1. A method of operating a cleaning compound/fresh water device, comprising:
applying a vacuum pressure to a liquid; and
passing the liquid the cleaning solution/fresh water device.

2. The method of claim 1 further comprising disposing the liquid.

3. The method of claim 2 further comprising transfers the liquid between a mop bucket and a disposal, and then filling the mop bucket with water.

4. A method of transferring a liquid between a mop bucket and a liquid station, comprising:
applying suction to the liquid;
processing the liquid; and
routing the liquid.

5. A method of claim 4 further comprising a start operation.

6. The method of claim 4 further comprising a select function.

7. The method of claim 4 further comprising a set-up.

8. The method of claim 4 further comprising a post operation.

9. The method of claim 4 further comprising a shut down.

10. The method of claim 4 further comprising filtering a liquid.

11. The method of claim 4 wherein processing sanitizes the liquid for providing a sanitized solution in order to sanitize a bucket or a mop.

12. The method of claim 4 further comprising adding a cleaning compound to the liquid.

13. The method of claim 4 further comprising applying suction for a pre-determined period of time for either emptying a mop bucket or filling the mop bucket.

14. The method of claim 4 wherein the start operation begins in response to a detection of a liquid.

15. The method of claim 6 wherein the select function act selects a fill function.

16. A cleaning compound/fresh water system, comprising:
an intake;
a pump enabled to pump liquids coupled to the intake; and
an outlet.

17. The system of claim 16 further comprising a timer coupled to the pump, a timer for controllably turning on and off the pump so that a direction of liquid flow and a duration of liquid flow may be controlled.

18. The system of claim 17 further comprising a means for adding a solution to the liquid, the means coupled to the pump.

19. The system of claim 16 further comprising a filter coupled to the pump.

20. The system of claim 16 further comprising a processor for controlling the functionality of the pump, the processor coupled to the pump.
